(19) United States
(12) Patent Application Publication
(10) Pub. No.: US 2026/0208268 A1
(43) Pub. Date: Jul. 23, 2026

(54) DEVICE AND METHOD FOR ADDITIVE MANUFACTURING WITH A PROTECTIVE GAS FLOW FOR PROTECTING AN OPTICAL ACCESS WINDOW

(71) Applicant: ADDUP, CEBAZAT (FR)

(72) Inventor: Sébastien DEVROE, CEBAZAT (FR)

(21) Appl. No.: 19/137,133

(22) PCT Filed: Dec. 14, 2023
(86) PCT No.: PCT/FR2023/052003

§ 371 Date: Jun. 9, 2025

(30) Foreign Application Priority Data
Dec. 14, 2022 (FR) FR2213392

(51) Int. Cl. B22F 12/70; B33Y 30/00; B33Y 40/00

(52) U.S. Cl. CPC B22F 12/70; B22F 2201/10; B33Y 30/00; B33Y 40/00

(57) ABSTRACT

The invention relates to an additive manufacturing device comprising:
an enclosure configured to contain powder and to produce a discharge gas flow against the powder,
a laser source configured to produce a laser beam and expose the powder to the laser beam through a window of the enclosure,
a blowing nozzle and a suction nozzle configured to produce a protective gas flow in the enclosure against the window.

### FIELD OF THE INVENTION

The invention relates to additive manufacturing and in particular to additive manufacturing wherein additive manufacturing powder is consolidated by laser beam. The optical access window is the window through which the laser beam passes.

### STATE OF THE ART

When additive manufacturing powder is consolidated by laser beam, the enclosure containing the powder has an optical access window to allow the laser beam to enter the enclosure. Exposing the powder to the beam generates a fusion plasma. Laser fumes may be produced in the enclosure. These can be deposited on the optical access window. To limit this pollution, a gas flow can be implemented along the window, but it is difficult to adjust this flow so that it protects the window without disturbing the flow of fluids in the enclosure. Adjustment becomes more difficult as the size of the optical access window increases.

There is a need to protect the optical access window from laser fumes more effectively and simply, without disrupting the flow of fluids in the enclosure.

### DISCLOSURE OF THE INVENTION

One aim of the invention is to provide an additive manufacturing device and method for protecting the optical access window from laser fumes more effectively and simply, without disrupting the flow of fluids in the enclosure.

The aim is achieved within the scope of the present invention by means of an additive manufacturing device comprising:
an enclosure configured to contain powder and to produce a discharge gas flow against the powder,
a laser source configured to produce a laser beam and expose the powder to the laser beam through a window of the enclosure,
a blowing nozzle and a suction nozzle configured to produce a protective gas flow in the enclosure against the window.

Such a device is advantageously and optionally completed by the following various features, taken alone or in combination:
the discharge gas flow is centered on a discharge plane parallel to a powder spreading plane distant from the discharge plane;
the protective gas flow is centered on a protection plane parallel to the window and distant from the protection plane, the protection plane being advantageously separated from the window by a distance less than or equal to 30 mm;
the blowing nozzle is configured to blow a blowing flow rate and the suction nozzle is configured to suck a suction flow rate, the blowing flow rate being strictly greater than the suction flow rate, a ratio of blowing flow rate to suction flow rate advantageously being greater than or equal to 1.3 and less than or equal to 3.0;
the blowing nozzle is configured to blow a blowing flow rate at a speed greater than or equal to one meter per second and at a pressure greater than a mean pressure in the enclosure;
the suction nozzle is configured to draw in a suction flow rate at a speed less than or equal to half a meter per second, and at a pressure less than a mean pressure in the enclosure;
a filtration system configured to filter a fluid drawn in by the suction nozzle and to feed the filtered fluid to the blowing nozzle;
the window extends over a first width in one direction, the suction nozzle and the blowing nozzle are configured to produce the protective flow over a second width in the direction, the second width being greater than or equal to the first width;
the suction nozzle and the blowing nozzle are configured so that the protective gas flow has a uniform flow rate over the second width, a relative difference in flow rate between two points of the second width being less than or equal to 5%; and
the suction nozzle and the blowing nozzle are configured so that the protective gas flow has a flow rate that increases with distance from a center of the window.

The invention also relates to an additive manufacturing method comprising the following steps:
producing a discharge gas flow against powder contained in an enclosure,
exposing the powder to a laser beam produced by a laser source, the beam passing through a window in the enclosure,
producing a protective gas flow in the enclosure against the window, the flow being produced by a blowing nozzle and a suction nozzle.

Such a method is advantageously and optionally completed by
the blowing nozzle blows a blowing flow rate and the suction nozzle draws a suction flow rate, the blowing flow rate being strictly greater than the suction flow rate, a ratio of blowing flow rate to suction flow rate advantageously being greater than or equal to 1.3 and less than or equal to 3.0, preferably, the blowing nozzle blows the blowing flow rate at a blowing speed greater than or equal to one meter per second, and at a pressure greater than a mean pressure in the enclosure, and preferably, the suction nozzle draws a suction flow rate at a suction speed less than or equal to half a meter per second, and at a pressure less than a mean pressure in the enclosure;
a step for filtering a fluid drawn in through the suction nozzle, and a step for blowing out the filtered fluid through the blowing nozzle;
the window extends over a first width in one direction, the protective gas flow having a uniform flow rate over a second width in the direction, the second width being greater than or equal to the first width, a relative difference in flow rate between two points of the third width being less than or equal to 5%; and
the window extends over a first width in one direction, the protective gas flow having a flow rate over a second width in the direction, the second width being greater than or equal to the first width, the flow rate increasing with distance from a center of the window.

### DESCRIPTION OF THE FIGURES

Further features and advantages of the invention will be apparent from the following description, which is purely illustrative and non-limiting, and should be read in conjunction with the appended drawings, in which:

FIGS. 1 and 2 are schematic representations of an additive manufacturing device according to one embodiment of the invention.

### DETAILED DESCRIPTION OF THE INVENTION

### Additive Manufacturing Device

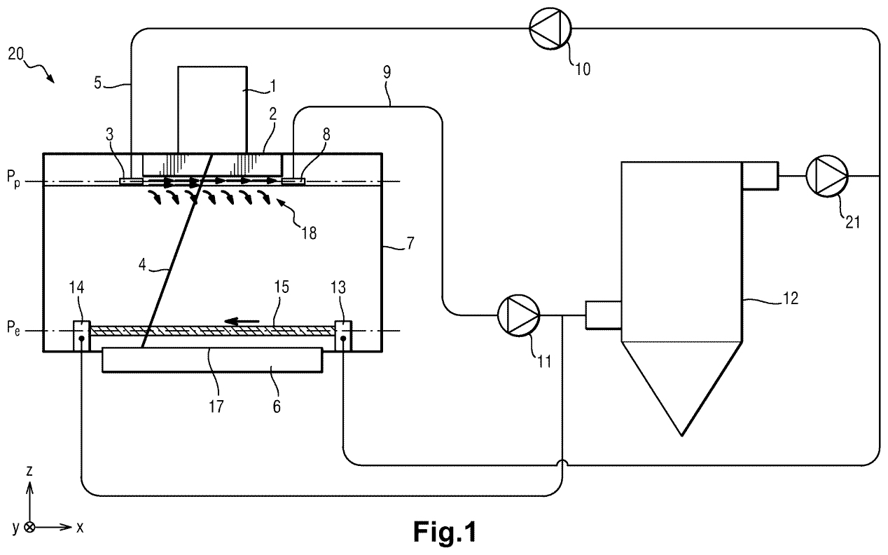

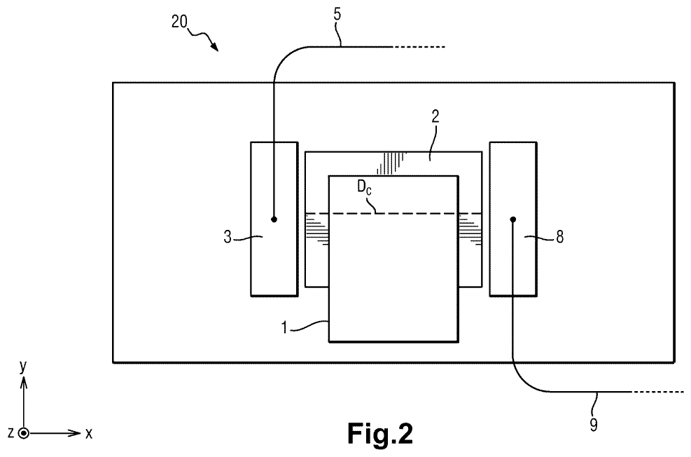

With reference to FIGS. 1 and 2, an additive manufacturing device 20 comprises an enclosure 7 configured to contain additive manufacturing powder 6. The enclosure 7 is a sealed enclosure wherein a gaseous environment is controlled. In particular, the gaseous environment can be composed of an inert gas. In this way, the gaseous environment in contact with the powder 6 does not alter the powder 6.

The powder 6 consists of a powdery material (metal powder, ceramic powder, etc.) intended to be consolidated layer by layer, by total or partial selective melting. The powder 6 can be spread along a spreading plane 17, which is preferably horizontal and located in a lower part of the enclosure 7.

With reference to FIGS. 1 and 2, the horizontal plane corresponds to the plane defined by the x and y axes. The vertical direction is given by the z axis, which is oriented upwards in these figures.

Melting is performed with a power source, in this case a laser source 1 configured to produce a laser beam and expose the powder 6 to the laser beam through a window 2 of the enclosure 7. The laser source is used to selectively consolidate areas of the powder exposed to the laser beam. The laser source 1, included in the additive manufacturing device 20, is located outside the enclosure 7 and opposite a window 2 located on one of the walls of the enclosure 7. The laser source 1 can emit a single laser beam 4, or several laser sources can emit several laser beams simultaneously.

The window 2 is transparent to the wavelength of the laser beam 4. In this way, little or no energy is lost from the laser beam 4 as it passes through the window 2.

The window 2 is preferably rectangular, horizontal and located in the upper part of the enclosure 7, facing the powder 6.

The enclosure 7 is configured to produce a discharge gas flow 15 against the powder 6. This gas flow is designed to discharge laser fumes produced during powder melting. For example, the discharge flow 15 is a laminar flow of inert gas generated inside the enclosure 7 against the powder 6. In particular, the discharge flow 15 flows over the powder 6 and has a flow rate high enough to carry away laser fumes produced during powder melting and low enough not to displace the powder 6. The gas flow 15 for example has a thickness 5 mm high above the powder at a speed of 1 to 2 meters per second. For example, two nozzles 13 and 14, positioned inside the enclosure, can be used to produce the gas flow 15.

Advantageously, the discharge gas flow 15 is centered on a discharge plane Pe parallel to a spreading plane 17 of the powder. When the spreading plane 17 is horizontal, the discharge plane Pe is also horizontal.

The spreading plane 17 is at a distance from the discharge plane Pe. The discharge flow 15 extends in a direction orthogonal to the discharge plane Pe so that the maximum flow rate is reached in the discharge plane or at least in an area surrounding the discharge plane Pe. The flow rate of the discharge flow 15 decreases moving away from the discharge plane Pe in the orthogonal direction. The distance between the spreading plane 17 and the discharge plane Pe is advantageously less than or equal to 4 millimeters. The distance can be between 1 and 4 millimeters and more advantageously between 2 and 3 millimeters.

The additive manufacturing device 20 further comprises a blowing nozzle 3 and a suction nozzle 8 configured to produce a protective gas flow 18 in the enclosure 7 against the window 2.

The blowing nozzle 3 is understood here as a device which blows a gas such as an inert gas. For example, the blowing nozzle 3 can be connected to a blowing manifold 10 via a blowing fan 5.

The suction nozzle 8 is understood here as a device which draws in a gas such as an inert gas. For example, the suction nozzle 8 can be connected to a suction manifold 11 via a suction fan 9.

The main direction of protective gas flow 18 is from the blowing nozzle 3 to the suction nozzle 8. The protective gas flow 18 is preferably a laminar flow of inert gas. The blowing nozzle 3 is inside the enclosure on one side of the window, and the suction nozzle 8 is inside the enclosure on the other side of the window, so that both nozzles are inside the enclosure 7 and facing one another.

Between these two nozzles, the protective gas flow 18 flows against the window inside the enclosure 7.

Compared with the prior art, the use of the blowing nozzle 3 and the suction nozzle 8 makes it easier to control the characteristics of the protective gas flow, and the window can be protected more effectively from laser fumes. In particular, it is possible to produce a laminar gas flow capable of protecting larger windows than in the prior art. It is also possible to protect the window with a flow rate lower than a disturbance flow rate. The disturbance flow rate is a flow rate at which the protective flow disturbs the flow of gases in the gaseous environment of the enclosure 7, such as the diffusion of laser fumes in the enclosure 7 or the discharge flow 15 flowing against the powder 6.

Advantageously, the protective gas flow 18 is centered on a protection plane Pp parallel to the window 2. When the window 2 is horizontal, the protection plane Pp is also horizontal, and the blowing nozzle 3 and suction nozzle 8 are separated by a horizontal distance, for example along the x axis.

The window 2 is separated from the protection plane Pp. The protective flow 18 extends in a direction orthogonal to the protection plane Pp, so that the maximum flow rate is reached in the protection plane Pp or at least in an area surrounding the protection plane Pp. With increasing distance from the protection plane Pp in the orthogonal direction, the flow rate of the protective flow Pp decreases. The distance between the protection plane Pp and the window 2 is advantageously less than or equal to 30 millimeters. The distance can be between 5 and 25 millimeters and more advantageously between 7 and 15 millimeters. The closer the nozzles 3, 8 are positioned to the window 2, the easier it is to achieve a laminar flow of the protective flow 18: lower protective flow rates enable laminar flow of the protective flow 18. In this way, the window can be protected from laser fumes at flow rates even further away from the disturbance flow rate.

The blowing nozzle 3 is configured to blow a blowing flow rate ds and the suction nozzle 8 is configured to draw a suction flow rate da. The blowing flow rate ds is advantageously chosen to be strictly greater than the suction flow rate da. This prevents the suction nozzle from drawing in laser fumes from the laser melting method. In this situation, only part of the flow blown out by the blowing nozzle is drawn in by the suction nozzle. Part of the blown air flow moves away from the area, and in particular from the window. There is therefore a component of the protective flow 18 that pushes laser fumes further away from the window.

A further fluid circulation system in the enclosure 7 can draw air into the enclosure so that the part of the flow blown by the blowing nozzle that is not drawn by the suction nozzle does not disturb the mean pressure inside the enclosure and more generally the circulation of gases in the enclosure.

When the blowing flow rate ds is chosen to be greater than the suction flow rate da, a ratio ds/da of blowing flow rate to suction flow rate is chosen, advantageously greater than or equal to 1.3 and less than or equal to 3.0. In particular, the ratio can be adjusted according to the geometry of the window and the length separating the blowing nozzle 3 and the suction nozzle 8: if this length increases, a lower ratio ds/da can be chosen.

As an option for the blowing nozzle, the fluid blown through the blowing nozzle can be blown at a blowing speed greater than or equal to one meter per second and at a pressure greater than an average pressure in the enclosure. For this purpose, the blowing nozzle 3 can be connected to the blowing manifold 5, whose pressure is higher than the pressure prevailing in the enclosure 7, allowing a blowing speed greater than or equal to 1 m/s.

As an option for the suction nozzle, the fluid drawn in by the suction nozzle can be drawn in at a suction speed of less than or equal to half a meter per second and at a pressure lower than a mean pressure in the enclosure. For this purpose, the suction nozzle 8 can be connected to the suction manifold 9, whose pressure is lower than the pressure prevailing in the enclosure 7, allowing a suction speed less than or equal to 0.5 m/s.

In one embodiment, the device 20 comprises a filtration system 12. The filtration system 12 is configured to filter the fluid drawn in by the suction nozzle and to feed the filtered fluid to the blowing nozzle. In other words, the filtration system 12 creates a gas circulation loop for the protective flow 18. Once filtered, the gas drawn in by the suction nozzle 8 is recirculated to the blowing nozzle 3, which blows it back against the window 2.

For this embodiment, the following can be used:
the blowing fan 10, which, as previously described, is fluidly connected to the blowing nozzle 3 via the blowing manifold 5, and
the suction fan 11, which, as previously described, is fluidly connected to the suction nozzle 8 via the suction manifold 9.

In this case, the blowing fan 10 can be fluidly connected to an outlet of the filtration system 12 and the suction fan 11 to an inlet of the filtration system 12.

A main fan 21 can also be added to ensure a minimum flow rate in the gas circulation loop of the protective flow 18. For example, the main fan is fluidly connected to the outlet of the filtration system 12.

According to a configuration shown in FIG. 1, the filtration system 12 can also be configured to filter the fluid from the discharge gas flow 15 that flows against the powder 6. To this end, the two nozzles 13 and 14 that produce the discharge gas flow 15 are fluidly connected to the filtration system 12. One of the nozzles 13 and 14 is fluidly connected to the inlet of the filtration system 12, and the other of the nozzles 13 and 14 is fluidly connected to the outlet of the filtration system 12. If the system comprises a main fan 21 fluidly connected to the outlet of the filtration system 12, the outlet of the main fan 21 can be fluidly connected on the one hand to the blowing nozzle 3 via the blowing manifold and on the other hand to one of the nozzles 13 and 14 which produce the discharge gas flow 15.

The window 2 can extend over a first width in one direction, the suction nozzle and the blowing nozzle are configured to produce a protective flow over a second width in the direction, the second width being greater than or equal to the first width.

The aforementioned direction can be described as transverse, that is to say orthogonal to the main direction of the protective flow. The main flow direction is the direction in which the blowing nozzle 3 and the suction nozzle 8 face one another.

Preferably, the window 2 is rectangular and the transverse flow direction and the main flow direction correspond to the side directions of the rectangle formed by the window.

When the window 2 is horizontal, the transverse direction is horizontal. If the blowing nozzle 3 and the suction nozzle 8 are separated by a horizontal distance along the x axis, then the transverse direction is parallel to the y axis, as shown in FIG. 2.

To ensure that the second width in the direction is greater than or equal to the first width, it is possible, for example, to select a suction nozzle and a blowing nozzle which extend in the transverse direction along a third width greater than the first width of the window.

In a first variant, the flow rate of the protective gas flow is uniform over the second width. In other words, when a segment directed in the transverse direction through the protective gas flow is selected, the flow rate at each point of this segment remains constant or substantially constant. Constant or substantially constant is taken to mean a relative difference in flow rate between two points of the second width of less than or equal to 5%.

In a second variant, the flow rate of the protective gas flow is variable over the second width and, more precisely, the flow rate increases with distance from a center of the window. In other words, when a segment directed in the transverse direction through the protective gas flow is selected, the flow rate at each point of this segment varies along the segment. The flow rate is minimum at a central point of the segment, corresponding to the center of the window. The flow rate increases on both sides of this central point. Center of the window is understood to mean a central direction of the window oriented along the main flow direction and orthogonal to the transverse direction. The central direction passes through the center of the window. For example, and in relation to FIG. 2, when the window 2 is rectangular, the central direction Dc passes through the center of the rectangle and is parallel to two of the rectangle's sides: this is one of the rectangle's axes of symmetry.

### Additive Manufacturing Method

An additive manufacturing device 20 of the type described above can be used to implement an additive manufacturing method comprising the following steps.

In a first step, a discharge gas flow 15 is produced against the powder 6 contained in the enclosure 7. This flow is intended to discharge the laser fumes produced during melting of the powder 6.

In a second step, the powder 6 is exposed to a laser beam produced by the laser source 1 through the window 2 of the enclosure 7. This step provides the powder 6 with sufficient energy to cause consolidation. Laser fumes may

1. An additive manufacturing device comprising:
an enclosure configured to contain powder and to produce a discharge gas flow against the powder,
a laser source configured to produce a laser beam and expose the powder to the laser beam through a window of the enclosure,
a blowing nozzle and a suction nozzle configured to produce a protective gas flow in the enclosure against the window,
the blowing nozzle being configured to blow a blowing flow rate and the suction nozzle being configured to draw a suction flow rate, the blowing flow rate being strictly greater than the suction flow rate.

2. The device according to claim 1, wherein the discharge gas flow is centered on a discharge plane parallel to a powder spreading plane distant from the discharge plane (Pe).

3. The device according to claim 1, wherein the protective gas flow is centered on a protection plane (Pp) parallel to the window and distant from the protection plane (Pp), the protection plane (Pp) being advantageously separated from the window by a distance less than or equal to 30 mm.

4. The device according to claim 1, wherein a ratio of blowing flow rate to suction flow rate is greater than or equal to 1.3 and less than or equal to 3.0.

5. The device according to claim 1, wherein the blowing nozzle is configured to blow a blowing flow rate
at a speed greater than or equal to one meter per second and,
at a pressure greater than the mean pressure in the enclosure.

6. The device according to claim 1, wherein the suction nozzle is configured to draw in a suction flow rate
at a speed less than or equal to one half-meter per second, and
at a pressure less than the mean pressure in the enclosure.

7. The device according to claim 1, comprising a filtration system configured to filter a fluid drawn in by the suction nozzle and to feed the filtered fluid to the blowing nozzle.

8. The device according to claim 1, wherein the window extends over a first width in one direction (y), the suction nozzle and the blowing nozzle are configured to produce the protective flow over a second width in the direction (y), the second width being greater than or equal to the first width.

9. The device according to claim 8, wherein the suction nozzle and the blowing nozzle are configured so that the protective gas flow has a uniform flow rate over the second width, a relative difference in flow rate between two points of the second width being less than or equal to 5%.

10. The device according to claim 8, wherein the suction nozzle and the blowing nozzle are configured so that the protective gas flow has a flow rate that increases with distance from a center of the window.

11. An additive manufacturing method comprising the following steps:
producing a discharge gas flow against powder contained in an enclosure,
exposing the powder to a laser beam produced by a laser source, the beam passing through a window in the enclosure.
producing a protective gas flow in the enclosure against the window, the flow being produced by a blowing nozzle and a suction nozzle, the blowing nozzle blowing a blowing flow rate and the suction nozzle drawing a suction flow rate, the blowing flow rate being strictly greater than the suction flow rate.

12. The method according to claim 11, wherein a ratio of blowing flow rate to suction flow rate is greater than or equal to 1.3 and less than or equal to 3.0, preferably, the blowing nozzle blows the blowing flow rate at a blowing speed greater than or equal to one meter per second, and at a pressure greater than a mean pressure in the enclosure, and preferably, the suction nozzle draws a suction flow rate at a suction speed less than or equal to half a meter per second, and at a pressure less than a mean pressure in the enclosure.

13. The method according to claim 11, comprising a step for filtering a fluid drawn in through the suction nozzle, and a step for blowing out the filtered fluid through the blowing nozzle.

14. The method according to claim 11, wherein the window extends over a first width in one direction (y), the protective gas flow having a uniform flow rate over a second width in the direction (y), the second width being greater than or equal to the first width, a relative difference in flow rate between two points of the third width being less than or equal to 5%.

15. The method according to claim 11, wherein the window extends over a first width in one direction (y), the protective gas flow having a flow rate over a second width in the direction (y), the second width being greater than or equal to the first width, the flow rate increasing with distance from a center of the window.
